(19) United States
(12) Patent Application Publication
(10) Pub. No.: US 2005/0051600 A1
(43) Pub. Date: Mar. 10, 2005

(54) Method and system for stud bumping

(75) Inventors: Greg E. Howard, Allen, TX (US); Leland S. Swanson, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/659,415

(22) Filed: Sep. 10, 2003

(51) Int. Cl. B23K 20/12

(52) U.S. Cl. 228/112.1

(57) ABSTRACT

According to one embodiment of the invention, a method of stud bumping includes providing a bonding head having a plurality of wire passages formed therein, disposing a plurality of wires through respective ones of the plurality of wire passages, providing a substrate having a plurality of bond pads, engaging the wires with respective ones of a first set of the bond pads, and forming a first set of stud bumps outwardly from respective ones of the first set of the bond pads.

### TECHNICAL FIELD OF THE INVENTION

This invention relates generally to the field of integrated circuit fabrication and, more specifically, to a method and system for stud bumping.

### BACKGROUND OF THE INVENTION

The typical stud bumping process in integrated circuit manufacturing uses a conventional conductive ball, such as a gold ball, wire bonded to a conventional aluminum pad, and after the ball is bonded to the pad, the wire is cut at the base of the ball, leaving a “stud” metallurgically attached to the pad.

Many factors determine whether or not integrated circuit packages having stud bumps are fabricated in a cost effective manner. One such factor is the time to complete the stud bumping process. Time is money in any industry, but saving time is especially important in the high volume industries, such as the integrated circuit industry. Another factor for cost effective fabrication is bond quality for stud bumps. Bond quality affects integrated circuit reliability, which is important to consumers of integrated circuits.

### SUMMARY OF THE INVENTION

According to one embodiment of the invention, a method of stud bumping includes providing a bonding head having a plurality of wire passages formed therein, disposing a plurality of wires through respective ones of the plurality of wire passages, providing a substrate having a plurality of bond pads, engaging the wires with respective ones of a first set of the bond pads, and forming a first set of stud bumps outwardly from respective ones of the first set of the bond pads.

Some embodiments of the invention provide numerous technical advantages. Other embodiments may realize some, none, or all of these advantages. For example, a stud bumping process as described herein may be utilized to reduce the original bumping time by an order inversely proportional to the number of bumps used in a multiple wire reel bonding head. This makes the stud bumping process very attractive for high pin count devices. In addition, the stud bumping process increases the attractiveness of wire bonded packages versus solder bump packages, such as flip chips.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIGS. 1A and 1B are perspective and cross-sectional views, respectively, of a system for stud bumping in accordance with one embodiment of the present invention; and

FIGS. 2A through 2D are a series of cross-sectional elevation views illustrating an example method of stud bumping in accordance with one embodiment of the present invention.

### DETAILED DESCRIPTION OF EXAMPLE EMBODIMENTS OF THE INVENTION

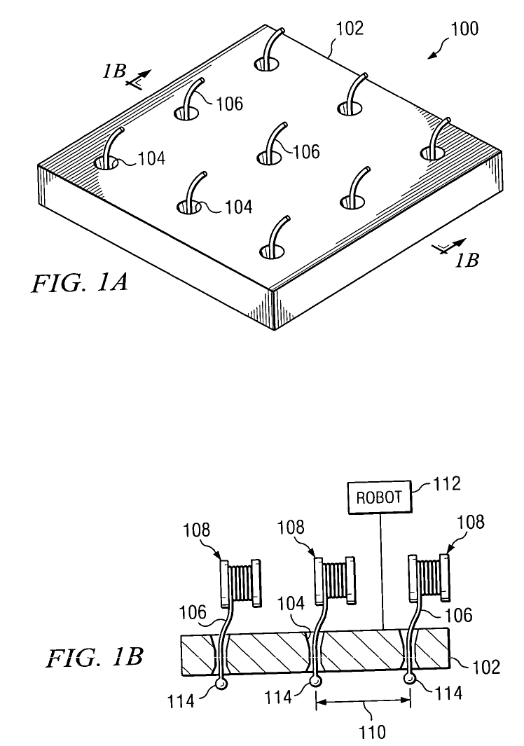

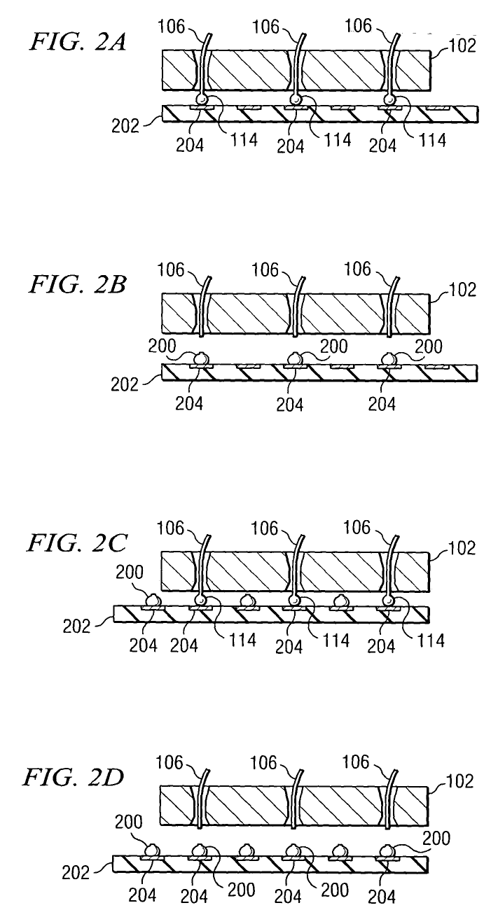

Example embodiments of the present invention and their advantages are best understood by referring now to FIGS. 1A through 2D of the drawings, in which like numerals refer to like parts.

FIGS. 1A and 1B are perspective and cross-sectional views, respectively, of a system 100 for stud bumping in accordance with one embodiment of the present invention. Generally, stud bumping is an integrated circuit manufacturing process that in which a conventional conductive ball, such as a gold ball, is wire bonded to a conventional aluminum pad, and after the ball is bonded to the pad, the wire is cut at the base of the ball, leaving a “stud” metallurgically attached to the pad. In the illustrated embodiment, system 100 includes a bonding head 102 having a plurality of wire passages 104 formed therein. Bonding head 102 is controlled by any suitable robot 112 and wire passages 104 are each configured to accept a suitable wire 106 disposed on a respective spool 108.

According to the teachings of one embodiment of the present invention, bonding head 102 is a multiple wire reel bonding head that may be utilized to simultaneously form a plurality of stud bumps on a substrate. An example method of simultaneously forming a plurality of stud bumps on a substrate is described in detail below in conjunction with FIGS. 2A through 2D.

Bonding head 102 may be any suitable size and shape and may be formed from any suitable material. In a particular embodiment, bonding head 102 is generally rectangularly shaped and is formed from a ceramic material. Although bonding head 102 is illustrated in FIG. 1A as having a rectangular array of wire passages 104, any suitable pre-defined pattern of wire passages 104 may be formed in bonding head 102. For example, bonding bead 102 may have a linear array of wire passages 104 or may have a random array of wire passages 104. Typically, the pattern of wire passages 104 formed in bonding head 102 substantially matches a pattern of bond pads on the substrate to which the stud bumps are desired to be formed. This is described in more detail below in conjunction with FIGS. 2A through 2B. As described above, bonding head 102 is controlled by a single robot 112, which may be any suitable robot controlled by any suitable controller.

Wire passages 104, which are also known as capillaries in the integrated circuit industry, are each configured to accept a suitable wire 106 therein. Wires 106 are typically of a very small diameter and are formed from any suitable material, such as gold, aluminum, or other suitable material. Any suitable spools 108 may be used to contain wires 106. Also illustrated in FIG. 1B is a ball 114 disposed at the end of each wire 106. The formation and use of balls 114 for the stud bumping as well as the wire bonding process is well known in the industry. Wire passages 104 may have any suitable profile and are formed in bonding head 102 using any suitable method. As denoted in FIG. 1B, a pitch 110 of wire passages 104 may be any suitable pitch. In one embodiment, pitch 110 between any two adjacent wire passages 104 is no more than 1000 microns. In a more particular embodiment of the invention, pitch 110 is no more than approximately 200 microns. This facilitates a technical advantage of bonding head 102 in that stud bumps that are closely spaced may be formed in a much more cost efficient manner than existing stud bump methods in which stud bumps are formed one at time. In fact, the bumping time may be reduced by an order inversely proportional to a number of wire passages 104 used in bonding head 102.

FIGS. 2A through 2D are a series of cross-sectional elevation views illustrating an example method of stud bumping in accordance with one embodiment of the present invention. In the illustrated example method, it is desired to produce a plurality of stud bumps 200 utilizing system 100 of FIGS. 1A and 1B. Accordingly, a substrate 202 having a plurality of bond pads 204 is provided as shown in FIG. 2A. Substrate 202 may be any suitable substrate formed from any suitable material. Bond pads 204 are any suitable metal contact pads formed in substrate 202. Bond pads 204 may have any suitable size and shape and may be formed in any suitable pattern. Bonding head 102 having wires 106 disposed in wire passages 104 is positioned by robot 112 in such a manner that balls 114 on the ends of wires 106 engage a first set of bond pads 204 on substrate 202. A suitable stud bumping process takes place to produce a plurality of stud bumps 200 on the first set of bond pads 204. The stud bumping process is well known in the industry, and the result is illustrated in FIG. 2B.

Referring to FIG. 2B, a plurality of stud bumps 200 are shown to be formed on the first set of bond pads 204. Stud bumps 200 are preferably formed simultaneously by bonding head 102. After the stud bumping process, bonding head 102 is raised a short distance above substrate 202 and may be moved to another suitable position to form other stud bumps. In addition, as a result of a suitable flash process, the ends of wires 106 are shown as broken. New balls 114 need to be formed on the ends of wires 106 to form other stud bumps, as illustrated below in FIG. 2C.

Referring to FIG. 2C, new balls 114 have been formed at the end of wires 106 and are brought in contact with a second set of bond pads 204 on substrate 202. The pattern of a second set of bond pads 204 substantially matches the pattern of the first set of bond pads 204 and, accordingly, substantially matches the pattern of wire passages 104 of bonding head 102. In this manner, bonding head 102 may be utilized to form a first set of stud bumps 200 on a first set of bond pads 204, then subsequently form a second set of stud bumps 200 on a second set of contact pads 204. Subsequent sets of stud bumps 200 may be formed on subsequent sets of bond pads 204, depending on the number and arrangement of bond pads 204 on substrate 202 in addition to the number and pattern of wire passages 104 on bonding head 102. This allows the size of bonding head 102 to be minimized, thereby potentially saving some money on the fabrication costs for bonding head 102. In an embodiment where substrate 202 has a relatively small number of bond pads 204, bonding head 102 may have enough wire passages 104 to complete the stud bumping process in one step.

Referring to FIG. 2D, a plurality of stud bumps 200 are shown to be formed on the second set of bond pads 204 in a manner as described above in conjunction with FIGS. 2A and 2B. Thus, bonding head 102, having a plurality of wire passages 104 and controlled by a single robot 112 is utilized to form stud bumps on bond pads of a substrate in a cost effective manner. Among other technical advantages, this makes the stud bumping process attractive for high pin count devices, in addition to increasing the attractiveness of wire bonded packages versus solder bump packages.

Although embodiments of the invention and their advantages are described in detail, a person skilled in the art could make various alterations, additions, and omissions without departing from the spirit and scope of the present invention, as defined by the appended claims.

1. A method of stud bumping, comprising:
providing a bonding head having a plurality of wire passages formed therein;
disposing a plurality of wires through respective ones of the plurality of wire passages;
providing a substrate having a plurality of bond pads;
engaging the wires with respective ones of a first set of the bond pads; and
forming a first set of stud bumps outwardly from respective ones of the first set of the bond pads.

2. The method of claim 1, wherein the bonding head is formed from a ceramic.

3. The method of claim 1, wherein the wires are formed from a material selected from the group consisting of gold and aluminum.

4. The method of claim 1, further comprising causing a pitch between any two adjacent wire passages to be no more than 1000 microns.

5. The method of claim 1, further comprising causing a pitch between any two adjacent wire passages to be no more than 200 microns.

6. The method of claim 1, further comprising causing the wire passages to resemble an array selected from the group consisting of a linear array and a rectangular array.

7. The method of claim 1, wherein the engaging and forming steps are each performed simultaneously.

8. The method of claim 1, further comprising forming a second set of stud bumps outwardly from respective ones of a second set of the bond pads.

9. A system for stud bumping, comprising:
a bonding head having a plurality of wire passages formed therein;
a plurality of wires disposed through respective ones of the plurality of wire passages;
a substrate having a plurality of bond pads; and
a robot coupled to the bonding head, the robot operable to form a first set of stud bumps outwardly from respective ones of a first set of the bond pads.

10. The system of claim 9, wherein the bonding head is formed from a ceramic.

11. The system of claim 9, wherein the wires are formed from a material selected from the group consisting of gold and aluminum.

12. The system of claim 9, wherein a pitch between any two adjacent wire passages is no more than 1000 microns.

13. The system of claim 9, wherein a pitch between any two adjacent wire passages is no more than 200 microns.

14. The system of claim 9, wherein the wire passages resemble an array selected from the group consisting of a linear array and a rectangular array.

15. The system of claim 9, wherein the robot is operable to simultaneously engage the wires with respective ones of the bond pads to form the stud bumps.

16. The system of claim 9, further comprising forming a second set of stud bumps outwardly from respective ones of a second set of the bond pads.

17. A bonding head for simultaneously forming a plurality of stud bumps outwardly from respective ones of a plurality of bond pads formed on a substrate, comprising:
a generally rectangular body;
an array of wire passages formed in the body, each wire passage configured to accept a wire, the array selected from the group consisting of a linear array and a rectangular array; and
wherein a pitch between any two adjacent wire passages is no more than 1000 microns.

18. The bonding head of claim 17, wherein the body is formed from a ceramic.

19. The bonding head of claim 17, wherein the wires are formed from a material selected from the group consisting of gold and aluminum.

20. The bonding head of claim 17, wherein a pitch between any two adjacent wire passages is no more than 200 microns.
